(19) United States
(12) Patent Application Publication
(10) Pub. No.: US 2020/0311605 A1
(43) Pub. Date: Oct. 1, 2020

(54) SYSTEM AND METHOD FOR EXTRACTING AND PARSING FREE TEXT AND AUTOMATING EXECUTION OF DATA ENTRY, DATA RETRIEVAL AND PROCESSES FROM THE EXTRACTED AND PARSED TEXT

(71) Applicant: Jacada Ltd., Herzliya (IL)

(72) Inventors: Gideon Hollander, Hod Ha'Sharon (IL); Osher Yadgar, Hod Ha'Sharon (IL)

(21) Appl. No.: 16/815,494

(22) Filed: Mar. 11, 2020

Related U.S. Application Data
(60) Provisional application No. 62/824,118, filed on Mar. 26, 2019.

(51) Int. Cl. G06N 20/00; G06F 9/451

(52) U.S. Cl. CPC G06N 20/00; G06F 9/451

(57) ABSTRACT

A processor executes a process including: retrieving a knowledge article from a knowledgebase, the knowledge article pertaining to an operation performed by an agent and which is to be automated; parsing the knowledge article to extract intents, conditions and instructions from the knowledge article; identifying data referenced in the knowledge article, including fields and screen elements on one or more display screens presented to the agent for performing the operation; and processing the identified data to generate executable code for an execution engine so as to automate the operation.

### CROSS-REFERENCE TO RELATED APPLICATIONS

This patent application claims priority under 35 U.S.C. § 119(e) from U.S. provisional patent application 62/824,119, filed on 26 Mar. 2019 in the names of Gideon Hollander, et al., the entirety of which is hereby incorporated by reference as if fully set forth herein.

### BACKGROUND AND SUMMARY

The present invention pertains to computer recognition of natural language text and automating execution of processes described in the text. More particularly, the present invention is directed to a system and method to improve user-to-computer interaction efficiency by having software that replicates the sequence of steps that a human undertakes in order to perform a defined process or task, specifically by automating the actions described in a natural language (for example, found in a knowledgebase or books).

Many workers in today's organizations utilize a computer to perform some or all of their daily job functions. Additionally, many organizations provide specific instructions to their employees on how to properly complete a process or task using the computer.

A contact center for an automobile insurance company serves as a good, non-limiting, illustrative example. When a caller phones the organization, they are typically, when so requested, connected with an agent of the organization. The caller states their intent, for example, to add a driver to their automobile insurance policy. The agent may then consult an internal document (typically referred to as a knowledge article or knowledge base article) to obtain a detailed sequence of steps that need to be performed using their computer and the various software systems at their disposal. These steps may include an application of business rules (for example, instructing the agent to use the billing system to retrieve the customer's credit score, or to ask the customer for additional data), and discrete actions (for example, instructing the agent to switch to a customer record management (CRM) system, retrieve the customer record, navigate to a specific screen, and add the new driver to the selected policy). Importantly, the knowledge article describing these steps to the employee is written in plain text (natural language) and displayed to the employee in that manner on his or her display screen. The organization typically stores in a database a collection of such knowledge articles explaining the steps that an employee should follow to accomplish a variety of different tasks, and this collection is referred to herein as a knowledgebase.

When business processes, rules, or procedures change, these changes are reflected in one or more knowledge articles in the knowledgebase. In this manner, organizations can ensure that the knowledgebase always reflects the most recent policies and procedures for employees to follow.

While systems and methods exist to automate interactions on a software system (typically called Robotic Process Automation or RPA), it would be desirable to provide the ability to read and parse a knowledgebase based on the customer's request (e.g.. adding a new driver to an existing insurance policy) and automatically convert the steps described in one or more knowledge articles of the knowledgebase so that they actually may be executed by RPA solutions.

Current RPA solutions require implementation of processes in either a computer language or a proprietary modelling environment. Specifically, a developer or analyst reviews the policies and/or procedures contained within the knowledgebase and “codes” these policies and/or procedures into a language that an RPA solution is able to understand.

It should be readily apparent that two significant disadvantages exist with these current solutions. First, the need to utilize resources to code knowledgebase-defined actions into actions that RPA solutions can understand is labor intensive, expensive and time consuming, in addition to being error prone. Second, whenever policies are updated in the knowledgebase, these changes need to be reflected in the RPA code, requiring manual changes that may take time to implement. This often results in the automated execution not matching current organizational best practices and the most up-to-date policies and procedures as reflected in the knowledgebase.

Accordingly, it would be desirable to overcome these limitations and obviate the need for manually coding (or converting) knowledgebase content. In particular, it would be desirable to provide a solution which can automatically read, parse, understand and execute processes which are described in the knowledgebase. This would also ensure that an organization's most current policies and procedures are always reflected in the executing automation code.

In one aspect of the invention, a method comprises: a processor retrieving a knowledge article from a knowledgebase, the knowledge article being written in free text and pertaining to an operation which can be performed by an agent and which is to be automated; the processor parsing the knowledge article to extract from the knowledge article a list of instructions for the operation; the processor identifying fields and screen elements corresponding to the extracted list of instructions on one or more display screens presented to the agent for performing the operation; and the processor processing the identified fields and screen elements to generate executable code for an execution engine so as to automate the operation.

In another aspect of the invention, a system comprises: a display device; one or more processors; and a tangible storage device. The tangible storage device stores therein instructions which, when executed by the one or more processors, cause the one or more processors to perform a method. The method comprises: retrieving a knowledge article from a knowledgebase, the knowledge article being written in free text and pertaining to an operation which can be performed by an agent and which is to be automated; parsing the knowledge article to extract from the knowledge article a list of instructions for the operation; identifying fields and screen elements corresponding to the extracted list of instructions on one or more display screens presented to the agent via the display device for performing the operation; and processing the identified fields and screen elements to generate executable code for an execution engine so as to automate the operation.

### BRIEF DESCRIPTION OF THE DRAWINGS

FIG. 1 shows an example embodiment of a processing system which may be employed in systems and methods disclosed herein.

FIG. 2 shows a conceptual entry in a knowledgebase expressed in natural language, as well as the dynamic addition of functionality onto the existing knowledgebase entry.

FIG. 3 illustrates an example of a process of replicating a sequence of steps that a human undertakes in order to perform a defined process or task in order to generate executable automation code.

FIG. 4 illustrates an overview of a learning phase of a process of mapping knowledgebase instructions to executable code.

FIG. 5 illustrates an example process of a mapping engine automatically generating executable automation code from a knowledge article.

FIG. 6 illustrates an example operation of parsing a knowledge article and extracting instructions and elements from the knowledge article, which may be included in the process of FIG. 5.

FIG. 7 illustrates an example process of identifying field names within knowledge text and on underlying applications on an agent desktop, which may be included in the process of FIG. 5.

FIG. 8 illustrates an example operation of converting text and elements into a computer executable format, which may be included in the process of FIG. 5.

FIG. 9 shows a flowchart of an example method of replicating a sequence of steps that a human undertakes in order to perform a defined process or task in order to generate executable automation code.

### DETAILED DESCRIPTION

In the description to follow an individual may be referred to as an “operator,” an “agent,” or an “employee.” It should be understood that these terms are used interchangeably, depending on context, to refer to an individual who performs a series of tasks according to an established set of procedures in order to accomplish a particular objective.

As is traditional in the field of the inventive concepts, embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the scope of the inventive concepts. Further, the blocks, units and/or modules of the embodiments may be physically combined into more complex blocks, units and/or modules without departing from the scope of the inventive concepts.

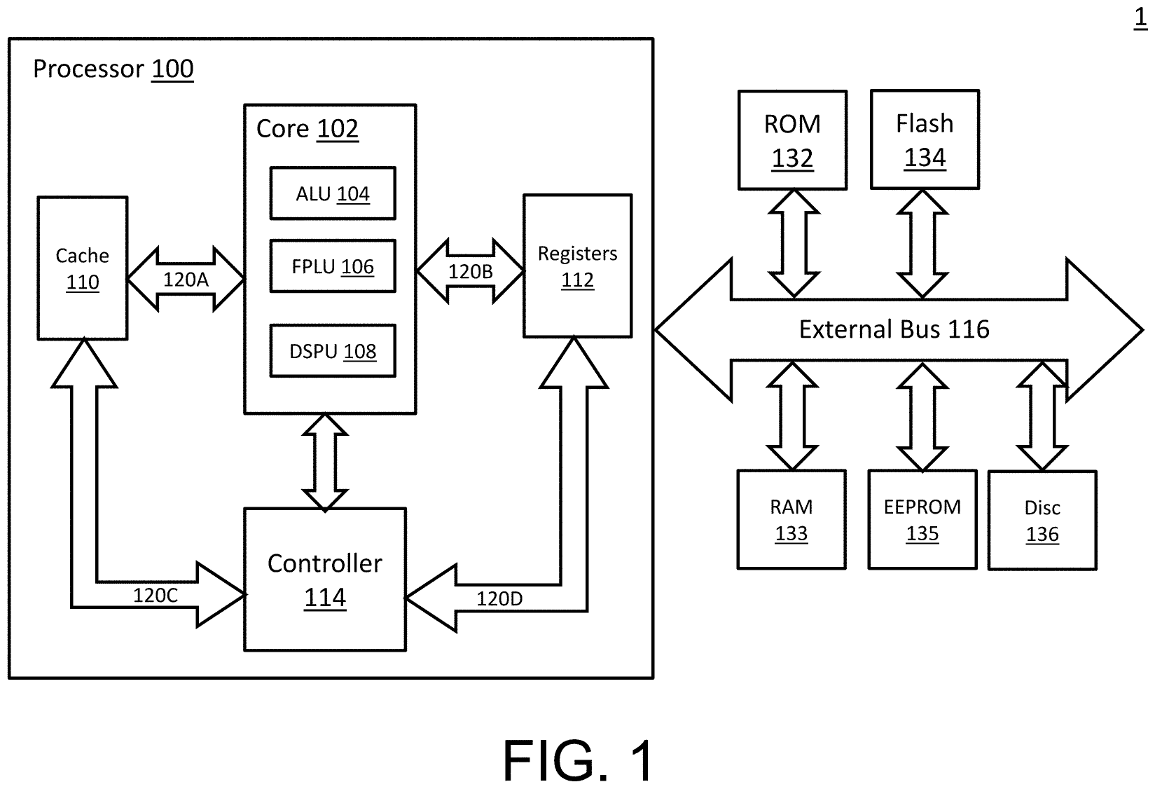

FIG. 1 shows an example embodiment of a processing system 1 which may be employed in systems and to perform methods disclosed herein. Processing system 1 includes a processor 100 connected to one or more external storage devices via an external bus 116.

Processor 100 may be any suitable processor type including, but not limited to, a microprocessor, a microcontroller, a digital signal processor (DSP), a field programmable array (FPGA) where the FPGA has been programmed to form a processor, a graphical processing unit (GPU), an application specific circuit (ASIC) where the ASIC has been designed to form a processor, or a combination thereof.

Processor 100 may include one or more cores 102. Core 102 may include one or more arithmetic logic units (ALU) 104. In some embodiments, core 102 may include a floating point logic unit (FPLU) 106 and/or a digital signal processing unit (DSPU) 108 in addition to or instead of ALU 104.

Processor 100 may include one or more registers 112 communicatively coupled to core 102. Registers 112 may be implemented using dedicated logic gate circuits (e.g., flip-flops) and/or any memory technology. In some embodiments registers 112 may be implemented using static memory. The register may provide data, instructions and addresses to core 102.

In some embodiments, processor 100 may include one or more levels of cache memory 110 communicatively coupled to core 102. Cache memory 110 may provide computer-readable instructions to core 102 for execution. Cache memory 110 may provide data for processing by core 102. In some embodiments, the computer-readable instructions may have been provided to cache memory 110 by a local memory, for example, local memory attached to external bus 116. Cache memory 110 may be implemented with any suitable cache memory type, for example, metal-oxide semiconductor (MOS) memory such as static random access memory (SRAM), dynamic random access memory (DRAM), and/or any other suitable memory technology.

Processor 100 may include a controller 114, which may control input to processor 100 from other processors and/or components included in a system and/or outputs from processor 100 to other processors and/or components included in the system. Controller 114 may control the data paths in ALU 104, FPLU 106 and/or DSPU 108. Controller 114 may be implemented as one or more state machines, data paths and/or dedicated control logic. The gates of controller 114 may be implemented as standalone gates, FPGA, ASIC or any other suitable technology.

Registers 112 and cache 110 may communicate with controller 114 and core 102 via internal connections 120A, 120B, 120C and 120D. Internal connections may be implemented as a bus, multiplexor, crossbar switch, and/or any other suitable connection technology.

Inputs and outputs for processor 100 may be provided via external bus 116, which may include one or more conductive lines. External bus 116 may be communicatively coupled to one or more components of processor 100, for example controller 114, cache 110, and/or register 112.

External bus 116 may be coupled to one or more external memories. The external memories may include Read Only Memory (ROM) 132. ROM 132 may be a masked ROM, Electronically Programmable Read Only Memory (EPROM) or any other suitable technology. The external memory may include Random Access Memory (RAM) 133. RANI 133 may be a static RAM, battery backed up static RANI, Dynamic RAM (DRAM) or any other suitable technology. The external memory may include Electrically Erasable Programmable Read Only Memory (EEPROM) 135. The external memory may include Flash memory 134. The external memory may include an optical or magnetic storage device such as disc 136.

Although a detailed description of processing system 1 which may be employed in systems and to perform methods disclosed herein has been described above as a concrete example, in general the operations described herein may be performed by a general purpose computer with any processor and memory, in particular a computer which operates with a standard operating system such as WINDOWS®, MACINTOSH® Operating System (“macOS”), UNIX, Linux, etc.

A discussed above, organizations today instruct employees on how to handle certain processes, and these instructions can be issued as a sequence of steps to be performed. Many organizations have developed a knowledgebase which consists of a collection of knowledge articles (sometimes also referred to as knowledge base articles) which are written in plain language (e.g., English) and are referenced by employees, typically via a computer display screen, as they perform corresponding tasks according to the instructions of the knowledge article(s).

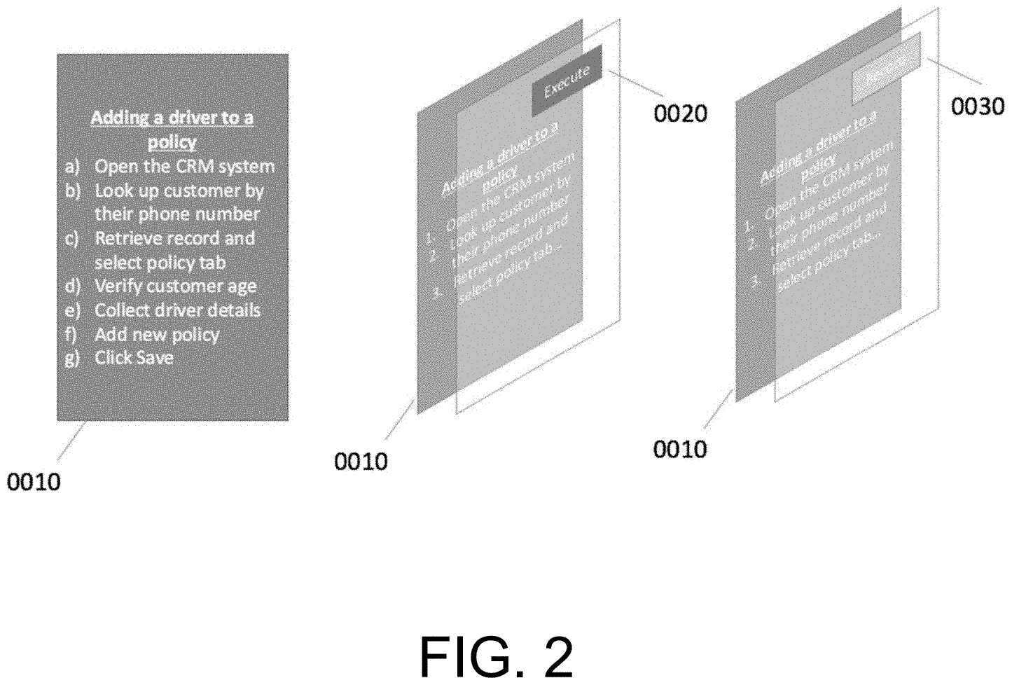

FIG. 2 shows a conceptual entry in a knowledge article expressed in natural language, as well as the dynamic addition of functionality onto the existing knowledge article. A knowledge article may numerically list a sequence of steps to be performed for a particular defined task or operation, as depicted in element 0010 of FIG. 2. Alternatively, a knowledge article may take other various structured and unstructured forms. Systems and methods described herein may identify, read and understand free-text knowledge articles in varying forms, and automate the execution of instructions contained in those articles, as discussed in detail below.

FIG. 2 additionally shows how additional functionality may be added to the existing knowledgebase by a system including a processor (e.g., processing system 1) executing a process automation process, as is described in further detail below.

In particular, FIG. 2 shows how a system executing a process automation process may be able to dynamically add actions (e.g., a button) (0020) onto an existing knowledgebase. This allows an organization to identify which steps or instructions in the knowledgebase are associated with a particular operation (e.g. “add a driver to a policy”) and provide a method by which an agent or employee can instruct the process automation process to automate execution of the steps associated with that operation. In this manner, once an agent or employee has identified the operation to be performed, the process automation process can be manually invoked by the employee and a processor performing the process automation process “knows” which steps to execute as part of the automation process. Utilizing a button is just one such example of how to invoke execution of the process automation process.

FIG. 2 also shows how a system executing a process automation process may provide an optional add-on component that dynamically layers ‘on-top’ of an existing knowledgebase an additional set of functionality. When an organization seeks to add a new entry in a knowledge article (or add an entirely new knowledge article), it can continue to author the entries as before in the manner provided by the knowledgebase. However, it can also optionally use the new “record” feature dynamically added (0030) by a system executing a process automation process. While the system executing the process automation process is primarily concerned with interpreting and automating knowledgebase entries, there may be certain phrasings that may be problematic or cause ambiguity conflicts. To improve on entries going forward and minimize error or ambiguity, utilizing the injected “record” functionality 0030 allows the author to create the instruction in a more consistent manner. This may be achieved by prompting the author for specific items, such as the entities affected, the systems used, the fields needed etc. This helps provide more rigidity to the natural language phrasing. Furthermore, upon saving the instruction from one or many users, a machine learning engine can indicate immediately whether the instruction is understood or whether clarification to the instruction is needed.

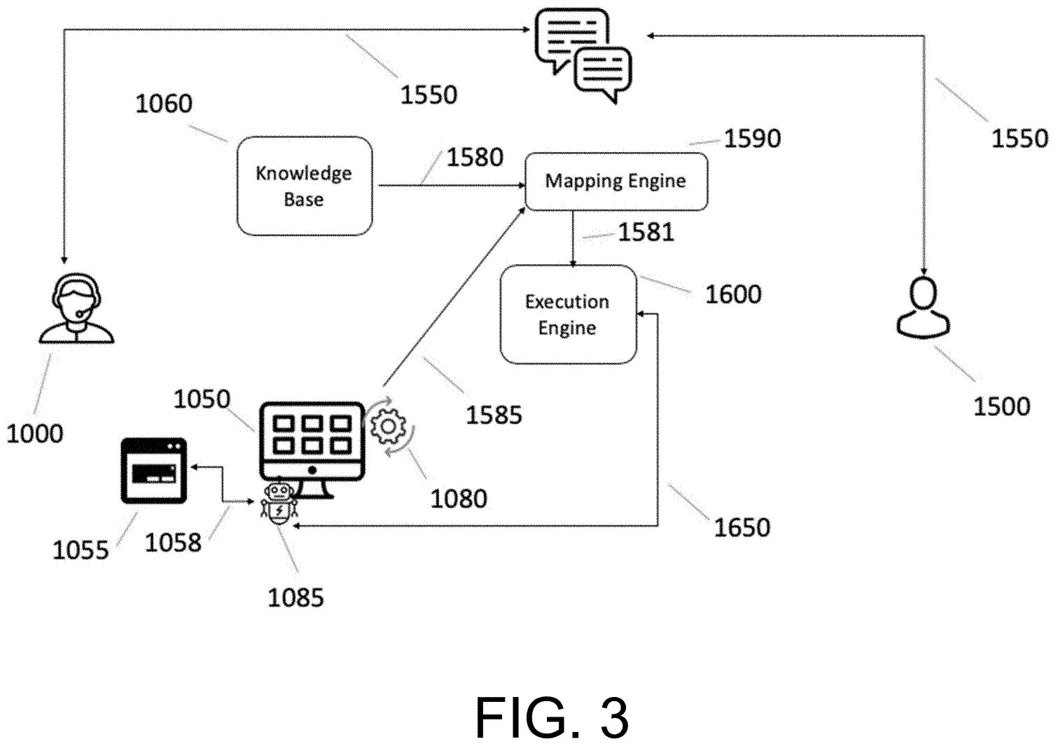

FIG. 3 illustrates an example of a process of replicating a sequence of steps that a human agent undertakes in order to perform a defined process or task, in order to generate executable automation code.

In more detail, FIG. 3 shows a customer 1500 engaging in a conversation 1550 with a contact center agent 1000. The medium in which the conversation 1550 happens may be voice (phone), or any other suitable means of communications such as online chat. Further, for illustrative purposes only, FIG. 3 shows an example pertaining to a contact center (i.e. ‘front-office’) but the principles can equally apply to other departments and more traditional ‘back-office’ tasks.

In still more detail, referring still to FIG. 3, the agent will typically determine the customer's intent—for example, to add a driver to their insurance policy. The agent 1000 will typically resolve the customer's request by consulting a knowledgebase 1060, and in particular a knowledge article (FIG. 2, element 0010) of knowledgebase 1060 which explains what steps should be followed and which rules should be adhered to in accomplishing the task of adding a driver to a customer's insurance policy. It should be noted that for illustrative purposes only, the knowledgebase 1060 is depicted in isolation. However, this knowledgebase 1060 will typically reside on the agent's computer 1050, stored in memory of computer 1050 and/or a remote computer to which agent's computer 1050 may be connected by a computer network, which may include the Internet. The agent 1000 utilizes the information in the knowledgebase and interacts with various applications which are accessible via the agent's computer 1050. The applications may be loaded onto and execute on the agent's computer 1050, or they may be client/server applications for which the agent's computer 1050 acts as an agent for the application which may be served from a remote server via a computer network.

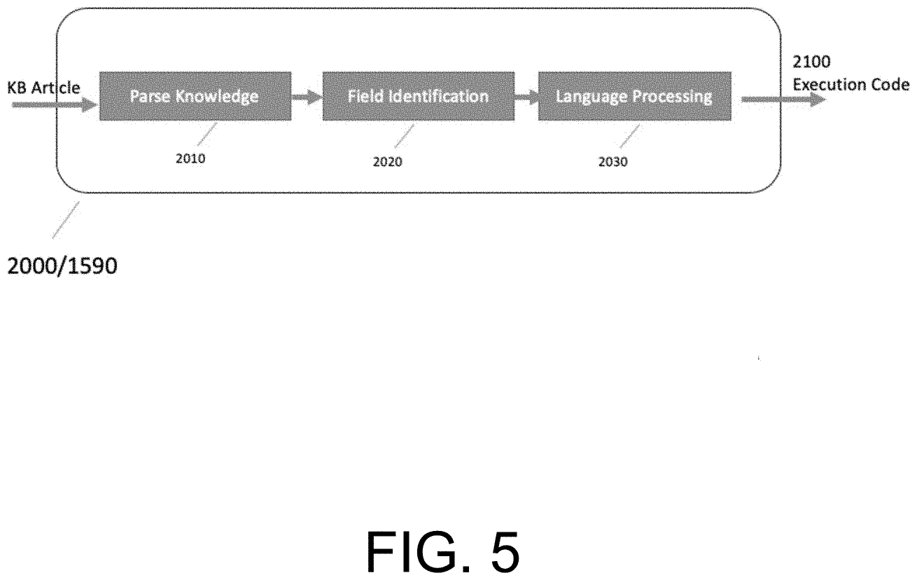

In more detail, FIG. 3 shows how the agent 1000 can retrieve the correct knowledge article from knowledgebase 1060 which includes instructions for performing a task corresponding to the customer intent, and invoke an automation sequence by pushing a dynamically superimposed link or button (FIG. 2, element 0020). The retrieved knowledge article is sent 1580 to the mapping engine 1590. The mapping engine 1590 is fully explained below with respect to FIGS. 5-8. Mapping engine 1590 is configured to accept a knowledge article expressed in natural language and utilize various mapping tables and algorithms to convert the naturally described instruction(s) of the knowledge article into a distinct sequence of structured steps that should be automated.

FIG. 3 also shows how the output 1581 from the mapping engine 1590 may be passed to the execution engine 1600. The execution engine 1600 can instruct 1650 a robotic process automation solution 1085 to enact certain steps on the desktop of agent's 1050. The execution engine 1600 utilizes an intermediary computer language to formulate the robotic automation instructions 1650 which can be dynamically cross-compiled or converted into the native language of any particular Robotic Process Automation solution. As a result, execution engine 1600 may work not only with its own automation solution, but in some embodiments can support any third-party robotic automation solution.

FIG. 3 additionally shows how ambiguity may be resolved, or more information may be collected when needed.

For example, in the event that additional information needs to be collected from the agent 1000 in order to complete a transaction via one or more applications on agent's computer 1050, the execution engine 1600 can instruct the robotic process automation (RPA) solution 1085 (or the software directly) that more information needs to be collected. RPA solution 1085 can invoke 1058 a form or dialog box 1055 which may be opened on a display screen of agent's computer 1050 and which agent 1000 can complete to provide the needed or missing information. Upon submission, RPA solution 1085, by itself or in conjunction with execution engine 1600, can complete the transaction.

Ambiguity may be resolved similarly. When execution engine 1600 is unable to ascertain the next task, a dialog box 1055 may be presented to the agent 1000 via a display screen of agent computer 1050 for the agent 1000 select the appropriate action. This corrective action may be sent back 1650 to the execution engine 1600 such that the execution engine 1600 can continue to utilize machine learning and, over time, be able to resolve that ambiguity by itself. This ambiguity may be reflected as machine learning feedback 1585 to the mapping engine 1590 in order to improve the performance/accuracy of mapping engine 1590.

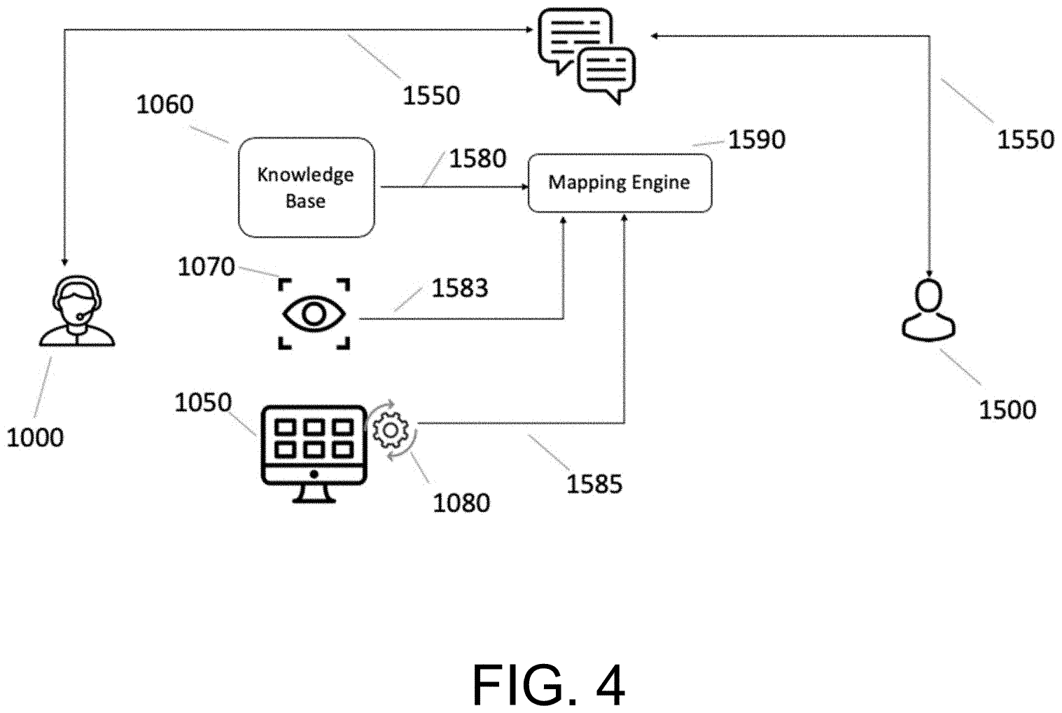

FIG. 4 illustrates an overview of a learning phase of a process of mapping knowledgebase instructions to executable code.

FIG. 4 shows how a system executing a process automation process utilizes technologies including, but not limited to, machine learning, artificial intelligence and eye tracking during the learning phase. During the learning phase, mapping engine 1590 learns to map natural language knowledgebase instructions to executable code.

Still referring to FIG. 4, mapping engine 1590 learns how to interpret knowledge articles/instructions by observing the interactions of agent 1000 occurring during an interaction with customer 1599. During this learning phase, agent 1000 engages in an interaction with a customer 1500 as fully described above during the discussion on FIG. 3. However, in this instance, when the agent retrieves the correct knowledge article, the agent pushes the record button (FIG. 2, element 0010) so that the specific agent steps can be monitored and recorded for subsequent automation.

Still referring to FIG. 4, mapping engine 1590 may optionally utilize eye tracking technology and track eye movements of agent 1000 in order to understand which applications, and which fields in which applications, agent 1000 is interacting with via agent's computer 1050. That is, an eye tracking device and application (“eye tracker”) 1070 may determine which areas of a display screen for agent's computer 1050 that agent 1000 is looking at while agent 1000 is performing the instructions for an operation. Further, another optional component, a desktop proxy 1080, may monitor interactions of agent occurring on the desktop of agent computer 1050, such as the data entered into a field on a screen of the desktop of agent computer 1050 and the corresponding field label. These data points 1583 from the eye tracker 1070 and the data points 1585 from desktop proxy 1080 may be sent as additional optional inputs to the mapping engine 1590 which combines these inputs to build automation code for the operation. The mapping engine 1590 is fully explained below with reference to FIGS. 5-8.

It should be noted that, for ease of explanation, the learning phase has been described separately from the execution phase. However, nothing herein should prevent the mapping engine from combining both phases, where continuous learning and execution can happen simultaneously.

FIG. 5 illustrates an example process of a mapping engine automatically generating executable automation code from a knowledge article.

FIG. 5 shows how an example embodiment of a mapping engine 2000 works. Mapping engine 2000 may be one embodiment of mapping engine 1590 discussed above.

Mapping engine 2000 retrieves the step or steps from the knowledge article based on the customer's intent (e.g., add a policy). Because the text is expressed in natural language, the knowledge article may be processed through a number of stages in order to produce the desired output of executable code. In a first stage 2010, the knowledge article may be parsed to extract the intents, conditions and instructions from the knowledge article. In a second stage 2020, the fields and screen elements are identified on the screen and as referenced in the knowledge article. In a third stage 2030, the information may be combined and processed to produce code for the execution engine. While only three phases are shown here, nothing should limit the mapping engine from adding to or subtracting from these phases. Moreover, the present embodiment employs three distinct phases but it should be readily understood that phases can be combined or separated in alternative ways.

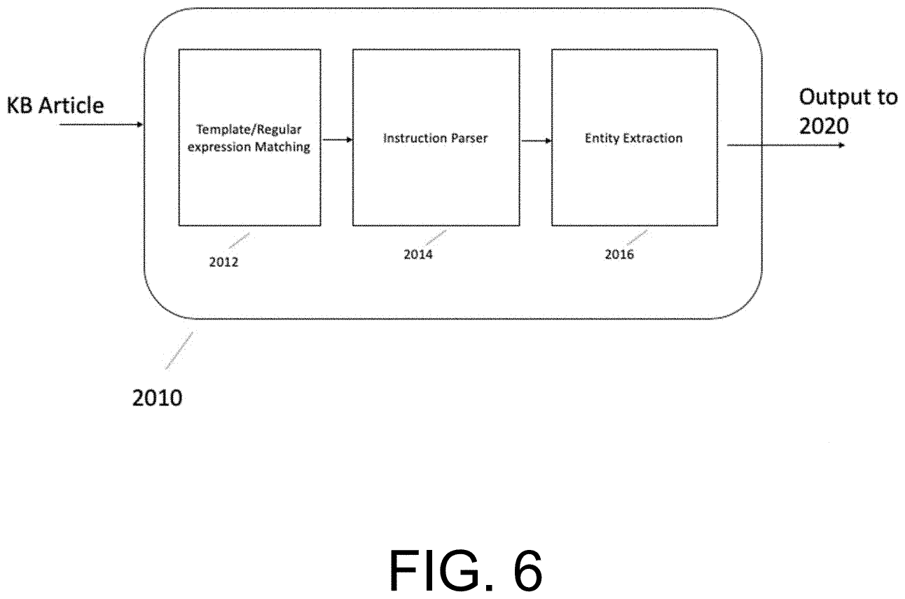

FIG. 6 illustrates an example operation of parsing a knowledge article and extracting instructions and elements from the knowledge article, which may be included in the process of FIG. 5.

FIG. 6 shows in more detail how a system (e.g., such as is shown in FIG. 3 and/or FIG. 4) executing a process automation process parses (or interprets) knowledge articles. Because a typical human-centric knowledge article is expressed in natural language and free text, the system executing a process automation process must parse out the text to find the list of instructions.

While one reasonably skilled in the art can appreciate that the order and types of mapping may vary, in some embodiments the mapping engine first applies template matching and/or regular expression matching to the input text in an operation 2012. Template matching increases recognition of which text in the knowledge article refers to the steps that need to be executed. For example, in FIG. 2, an example of element 0010 is shown wherein one organization may number their instructions or steps for an operation using alpha values (a, b, c, etc.). Another organization may utilize numerical sequences, and yet another may use a form of indentation. The mapping engine (e.g., elements 1590 and/or 2000) may have a template matching rule to better identify these steps based on that consistency and may optionally remap those to alternate values (1, 2, 3, etc.).

FIG. 6 also shows how the output from an operation 2012, consisting of the list of instructions, is parsed in an operation 2014. First, language processing techniques including but not limited to Tokenizers, Taggers and Parsers may be used to product Part-of-Speech data with dependencies. This assigns items like nouns, verbs, etc. to the words present in the instructions.

In addition, domain matching may be used to further improve accuracy of the instruction parsing. Domain matching refers to utilizing known terminology, vocabulary, Part-Of-Speech, tagging, dependencies, glossary, entities, syntax, semantics and actions from a particular industry vertical or specialization. For example, within the property and casualty insurance industry there are known terms (e.g., “Coverage”, “policy limits”, “named insured”, “liability,” etc.), known intents and actions (claims, policy changes, etc.), etc. This allows mapping engine 2000 to map local terminology to consistent phrases for easier processing. The domain knowledge can come from the customer knowledgebase and/or from other customers in the same vertical tier. In a typical implementation, mapping engine 2000 will come with its domains as a starting point and will be trained on the customer knowledgebase using machine learning techniques to improve parsing accuracy. An optional entity extraction operation 2016 may be further applied to extract entities from the extracted instructions in order to improve accuracy for the execution engine.

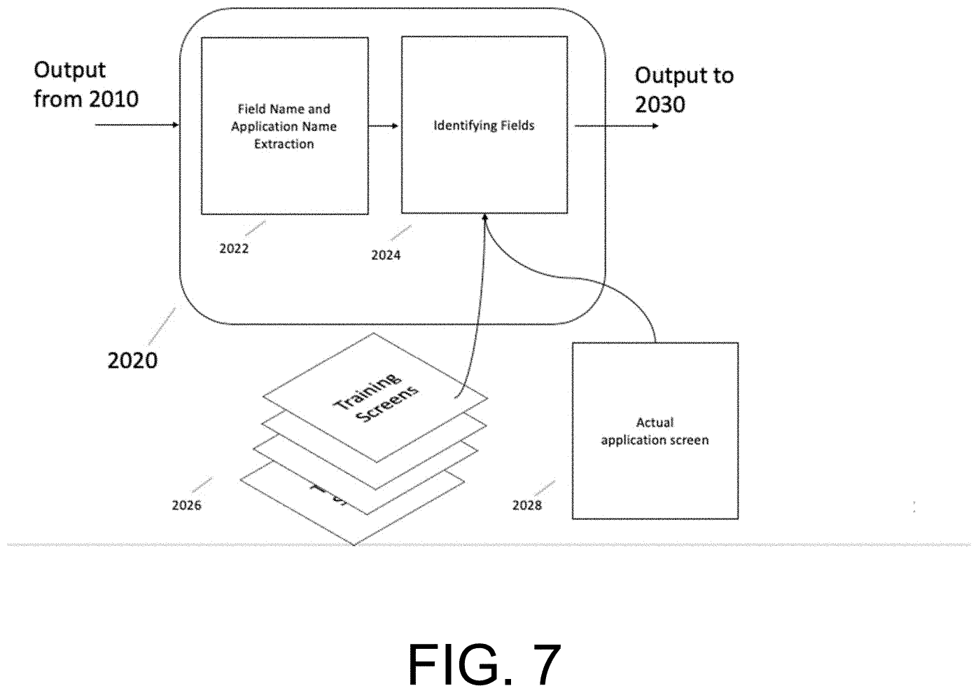

FIG. 7 illustrates an embodiment of second stage 2020 in FIG. 5 wherein field identification is performed. In particular, FIG. 7 illustrates an example process of identifying field names within knowledge text and in underlying applications on an agent desktop or agent computer 1050.

FIG. 7 shows how a system executing a process automation process may identify fields and field names in the applications. Instructions in the knowledgebase use descriptive application names (such as “CRM”, “Billing” etc.), and descriptive field names (such as “Customer No,”, “First Name” etc.). Mapping engine 2000 needs to know where these fields are in order to properly instruct Robotic Process Automation (“RPA”) solutions to type the data into the field or get the data from the field or screen. Humans are readily able to identify constructs such as “First Name: Joe” and know that the field name is “First Name” and the value is “Joe.” Mapping engine 2000 also needs to identify these constructs and interpret their values.

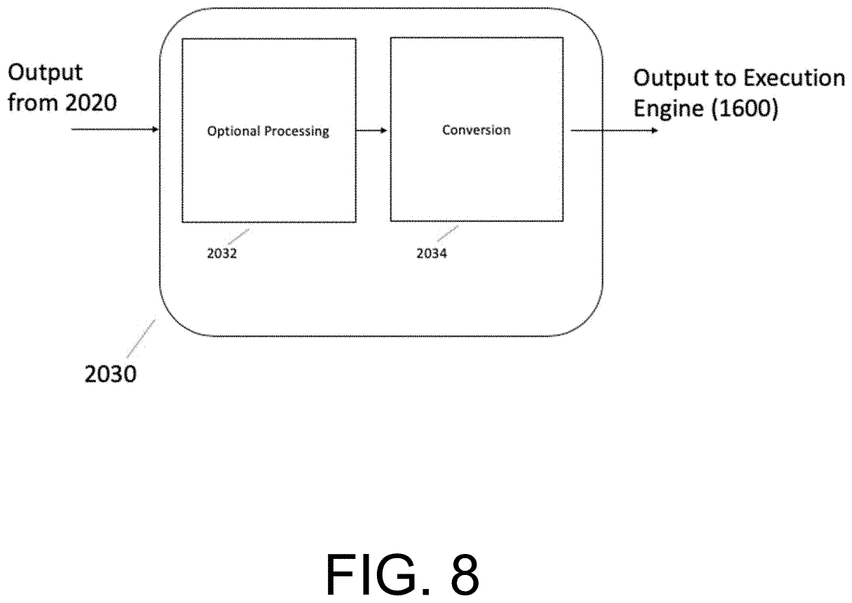

FIG. 7 also shows how mapping engine 2000 first extracts the field names and application names from the knowledge instructions in an operation 2022. Mapping engine 2000 then identifies in operation 2024 matching field(s), screen(s) and application(s) on the agent desktop (e.g., agent computer 1050 in FIGS. 3 and 4) to which this knowledge instruction is referring. In order to do so, mapping engine 2000 may be ‘taught’ by processing hundreds of training screens 2026 where each training screen may be provided along with the field name and value highlighted. Machine learning allows mapping engine 2000 to then take the actual application screen 2028 and, leveraging the training from sample training screens 2026, to be able to identify the field name and field (or field value) to use. During training, mapping engine 2000/1590 allows trainers to teach mapping engine 2000/590 where fields are located on a display screen by clicking a button to implement the Record function (FIG. 2, element 0030) in response to which mapping engine 2000 maps the screen-related instructions into the actual steps executed by the agent 1000 on the desktop or agent computer 1050. At this point, after operation 2024, mapping engine 2000/1590 now has all the information it needs to formulate executable code, which is explained with respect to FIG. 8.

FIG. 8 illustrates an embodiment of second stage 2020 in FIG. 5 wherein language processing is performed for converting text and elements of a natural language instruction into computer executable code in a computer executable format.

FIG. 8 shows that once the part-of-speech data and dependencies have been parsed, the parsed information can now be converted in an operation 2034 into executable code in a computer programming language. An optional additional processing operation 2032 can be performed to enhance the data quality before operation 2034. In operation 2034, a sentence of a natural language instruction in a knowledge article may be converted into a programming language with implied conditions and imperatives such as If-Then-Else constructs. For example, a knowledge instruction like ‘Enter M in the Gender field if the customer is Male or Type F if customer is Female’ may be translated into ‘If (customer is Male) {Input M in the Gender}; If (customer is Female) {Input F in the Gender};’. These sub sentences (like ‘customer is Female’ or ‘Input F in the Gender’), are further processed with natural language processing (NLP) machine learning techniques (such as the Seq2Seq algorithm) to translate it into structured instructions such as ‘If (customer is Male) {TypeInField(Gender,“M”)}; If (customer is Female) {TypeInField(Gender,“F”)};’ etc.

This output is now ready for the execution engine 1600 as described above with respect to FIG. 3.

The advantages of the arrangements described above may include, but are not limited to, dramatically improving agent efficiency by automating tasks in the knowledgebase, automatically generating automation code by interpreting the agent's interactions with the knowledgebase and underlying applications and keeping all business rules of an organization centralized in the knowledgebase.

Broadly, the arrangements described above may provide for the ability to dynamically take information contained in a knowledgebase and through a combination of monitoring agent behavior coupled with machine learning, automatically enact automation on the computer desktop.

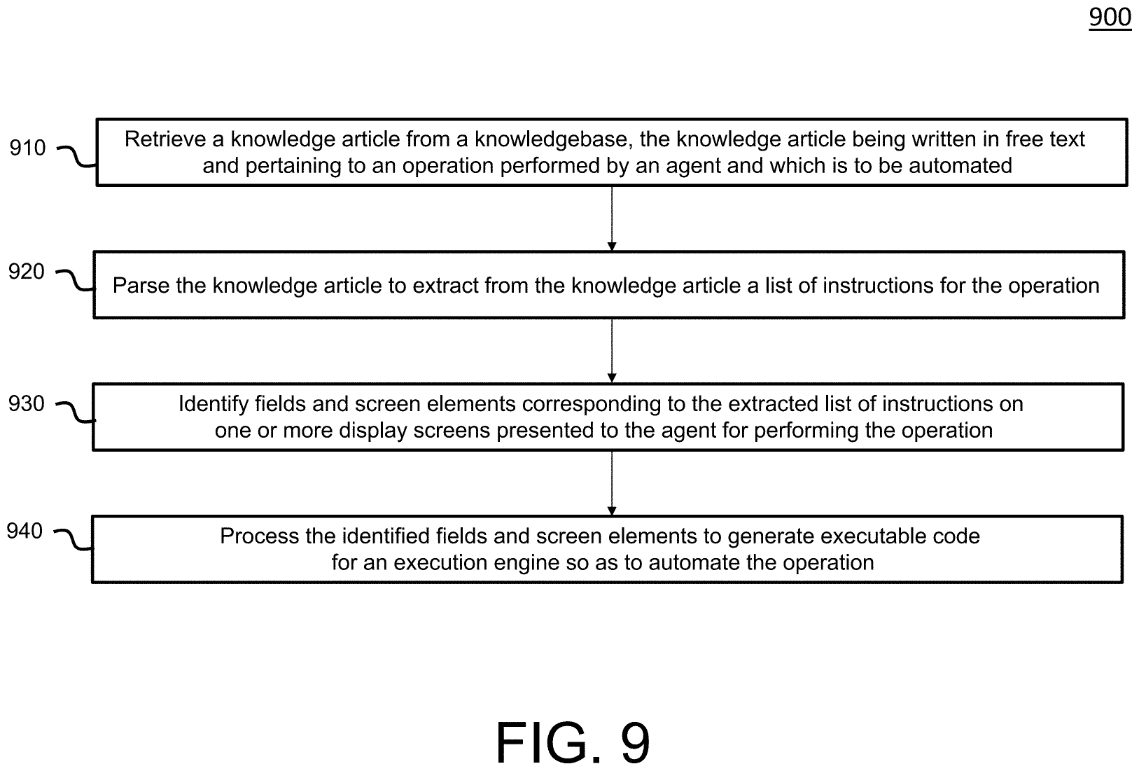

FIG. 9 shows a flowchart of an example method 900 of replicating a sequence of steps that a human undertakes in order to perform a defined process or task in order to generate executable automation code.

An operation 910 includes a processor retrieving a knowledge article from a knowledgebase, the knowledge article being written in free text and pertaining to an operation performed by an agent and which is to be automated.

An operation 920 includes the processor parsing the knowledge article to extract from the knowledge article a list of instructions for the operation.

An operation 930 includes the processor identifying fields and screen elements corresponding to the extracted list of instructions on one or more display screens presented to the agent for performing the operation.

An operation 940 includes the processor processing the identified fields and screen elements to generate executable code for an execution engine so as to automate the operation.

Software, and documentation thereof, which may be executed by a processor, such as processing system 1, or a computer which operates with a standard operating system such as WINDOWS®, MACINTOSH® Operating System (“macOS”), UNIX, Linux, etc., to perform one or more of the various operations described herein may be found at http://chilp.it/c47cc2d, the contents or which are incorporated by reference as if fully set forth herein.

While the foregoing written description enables one of ordinary skill to make and use what is considered presently to be the best mode thereof, those of ordinary skill will understand and appreciate the existence of variations, combinations, and equivalents of the specific embodiment, method, and examples herein. Such variations would become clear to one of ordinary skill in the art after inspection of the specification, drawings and claims herein. The invention should therefore not be limited by the above described embodiment, method, and examples, but by all embodiments of devices, systems, and methods within the scope and spirit of the invention.

We claim:

1. A method, comprising:
a processor retrieving a knowledge article from a knowledgebase, the knowledge article being written in free text and pertaining to an operation which can be performed by an agent and which is to be automated;
the processor parsing the knowledge article to extract from the knowledge article a list of instructions for the operation;
the processor identifying fields and screen elements corresponding to the extracted list of instructions on one or more display screens presented to the agent for performing the operation; and
the processor processing the identified fields and screen elements to generate executable code for an execution engine so as to automate the operation.

2. The method of claim 1, wherein the processor parsing the knowledge article to extract from the knowledge article the list of instructions for the operation includes:
retrieving from memory a template for the instructions of the knowledge article;
applying the template to the knowledge article to extract instructions for the operation; and
parsing the extracted instructions to assign one or more characteristics to one or more words included in the extracted instructions.

3. The method of claim 2, wherein identifying the fields and screen elements on one or more display screens presented to the agent for performing the operation corresponding to the extracted list of instructions comprises:
extracting applications, display screens, and field names from the extracted instructions;
identifying applications, display screens and fields which are displayed to the agent on the one or more display screens presented to the agent; and
mapping the extracted applications, display screens, and field names to the displayed applications, display screens, and field names, to identify fields and screen elements on the one or more display screens corresponding to the extracted list of instructions.

4. The method of claim 3, wherein identifying the displayed applications, the display screens, and the fields which are displayed to the agent on the one or more display screens presented to the agent, comprises:
processing a plurality of training screens with field names and values identified to the processor; and
applying machine learning to the training screens to identify the displayed applications, the training screens, and the fields which are presented to the agent on the one or more training screens.

5. The method of claim 4, further comprising the processor dynamically injecting a record button on at least one of the training screens.

6. The method of claim 5, wherein the field names and values are identified to the processor by one or more trainers executing a record operation by selecting the record button while processing the at least one training screen.

7. The method of claim 3, wherein identifying applications, display screens, and fields displayed to the agent on the one or more display screens presented to the agent, includes tracking an eye of the agent while the agent is interacting with the one or more display screens.

8. The method of claim 3, wherein identifying applications, display screens. and fields displayed to the agent on the one or more display screens presented to the agent, includes detecting areas of the one or more display screens where the agent enters data and/or navigates to with a mouse or trackball.

9. The method of claim 1, further comprising:
the agent receiving a communication from a customer indicating the operation which is to be automated;
the agent causing the processor to retrieve and display the knowledge article which pertains to the operation which is to be automated; and
the processor dynamically injecting an execute button on a display screen which displays the knowledge article,
wherein the parsing, identifying, and processing are performed in response to the agent selecting the execute button on the display screen.

10. A system, comprising:
a display device;
one or more processors; and
a tangible storage device storing therein instructions which, when executed by the one or more processors, cause the one or more processors to perform a method comprising:
retrieving a knowledge article from a knowledgebase, the knowledge article being written in free text and pertaining to an operation which can be performed by an agent and which is to be automated;
parsing the knowledge article to extract from the knowledge article a list of instructions for the operation;
identifying fields and screen elements corresponding to the extracted list of instructions on one or more display screens presented to the agent via the display device for performing the operation; and
processing the identified fields and screen elements to generate executable code for an execution engine so as to automate the operation.

11. The system of claim 10, wherein parsing the knowledge article to extract from the knowledge article the list of instructions for the operation includes:
retrieving from memory a template for the instructions of the knowledge article;
applying the template to the knowledge article to extract instructions for the operation; and
parsing the extracted instructions to assign one or more characteristics to one or more words included in instructions included in the extracted instructions.

12. The system of claim 11, wherein identifying the fields and screen elements on the one or more display screens presented to the agent for performing the operation corresponding to the extracted list of instructions comprises:
extracting applications, screens, and field names from the extracted instructions;
identifying applications, display screens, and fields which are displayed to the agent on the one or more display screens presented to the agent; and
mapping the extracted applications, display screens, and field names to the displayed applications, display screens, and field names, to identify fields and screen elements on one or more display screens corresponding to the extracted list of instructions.

13. The system of claim 12, wherein identifying the displayed applications, display screens, and fields which are displayed to the agent on the one or more display screens presented to the agent comprises:
processing a plurality of training screens with field names and values identified to the one or more processors; and
applying machine learning to the training screens to identify the displayed applications, the training screens, and the fields which are displayed to the agent on the one or more training screens.

14. The system of claim 13, wherein the method further includes dynamically injecting a record button on at least one of the training screens.

15. The system of claim 14, wherein the field names and values are identified to the one or more processors by one or more trainers executing a record operation by selecting the record button while processing the at least one training screen.

16. The system of claim 12, wherein identifying applications, display screens, and fields displayed to the agent on the one or more display screens presented to the agent, includes tracking an eye of the agent while the agent is interacting with the one or more display screens.

17. The system of claim 12, wherein identifying applications, display screens, and fields displayed to the agent on the one or more display screens presented to the agent, includes detecting areas of the one or more display screens where the agent enters data and/or navigates to with a mouse or trackball.

18. The system of claim 12, wherein the method further comprising dynamically injecting an execute button on a display screen which displays the knowledge article,
wherein the retrieving and displaying of the knowledge article which pertains to the operation which is to be automated are in response to the agent receiving a communication from a customer indicating the operation; and
wherein the parsing, identifying, and processing are performed in response to receiving a selection of the execute button on the display screen by the agent.
